(19) United States
(12) Patent Application Publication
(10) Pub. No.: US 2019/0219233 A1
(43) Pub. Date: Jul. 18, 2019

(54) LIGHT EMITTING DEVICE AND ILLUMINATING APPARATUS

(71) Applicant: PANASONIC CORPORATION, Osaka (JP)

(72) Inventors: Kiyoshi MORIMOTO, Osaka (JP); Kimihiro MURAKAMI, Osaka (JP)

(21) Appl. No.: 16/302,815

(22) PCT Filed: May 10, 2017
(86) PCT No.: PCT/JP2017/017627

§ 371 Date: Nov. 19, 2018

(30) Foreign Application Priority Data
May 23, 2016 (JP) 2016-102646

(51) Int. Cl. F21K 9/64; F21V 7/06; F21V 7/22; F21V 9/30; F21S 41/16; F21V 29/50

(52) U.S. Cl. CPC F21K 9/64; F21V 7/06; F21V 7/22; F21Y 2115/10; F21S 41/16; F21V 29/50; F21V 9/30

(57) ABSTRACT

A light emitting device includes: a laser light source which emits a laser beam; a fluorescent member which emits fluorescence when irradiated with the laser beam emitted from the laser light source; and a light separation element on which the laser beam and the fluorescence are incident and which causes the laser beam and the fluorescence to travel in mutually different directions.

### TECHNICAL FIELD

The present disclosure relates to a light emitting device and an illuminating apparatus, and particularly to a light emitting device that uses, as illuminating light, fluorescence emitted from a fluorescent member when the fluorescent member is irradiated with a laser beam from a laser light source, and an illuminating apparatus including the light emitting device, such as a headlamp or a spotlight.

### BACKGROUND ART

Recent years have seen active technological development regarding light emitting devices which irradiate a fluorescent member with a laser beam from a semiconductor laser element, and use fluorescence obtained by wavelength conversion as illuminating light. As a light emitting device as described above, an illuminating apparatus described in Patent Literature 1 (PTL 1) is known conventionally. The illuminating apparatus described in Patent Literature 1 will be described below with reference to FIG. 12.

As illustrated in FIG. 12, illuminating apparatus 1001 includes laser irradiating device 1002 which emits a bluish laser beam, fluorescent member 1003 which is irradiated with the bluish purple laser beam emitted from laser irradiating device 1002, light-scattering material 1004 disposed on the path of the optical axes of the laser beams denoted by L and the surrounding area, and reflecting mirror 1005.

Illuminating apparatus 1001 excites fluorescent member 1003 with the laser beam to convert the laser beam into visible light (white light, for example), and uses the visible light as illuminating light, and is used as a headlamp of a vehicle, for example.

Laser irradiating device 1002 includes semiconductor laser element 1002a which emits the bluish purple laser beam and condenser lens 1002b, for example. Fluorescent member 1003 includes a fluorescent material that emits blue-green light when excited by the bluish purple laser beam, and a fluorescent material that emits red light when excited by the bluish purple laser beam. Because of this, when fluorescent member 1003 is irradiated with the bluish purple laser beam, the blue-green light and the red light mix to produce white fluorescence.

Reflecting mirror 1005 is a metal parabolic mirror, for example, and includes concave portion 1005a which reflects visible light obtained from the conversion by fluorescent member 1003 forward (to the right in FIG. 12). A plurality of through holes 1005b are provided around the apex of reflecting mirror 1005, and fluorescent member 1003 disposed inside of concave portion 1005a is irradiated with the laser beam from outside of reflecting mirror 1005 via through holes 1005b. Light-scattering material 1004 is bonded to the back surface of cover 1006 so as to be located in front of fluorescent member 1003. Cover 1006 which is formed from a transparent resin and covers the front end face of reflecting mirror 1005 has a function of preventing dust and the like from entering inside of reflecting mirror 1005. Furthermore, filter 1007 which absorbs a laser beam having a peak wavelength of 405 nm and transmits white light is provided on the outer surface of cover 1006. Here, 99% of the laser beams are absorbed by filter 1007, but 1% of the laser beams inevitably leak outside. For this reason, light-scattering material 1004 is disposed at the back of filter 1007 in illuminating apparatus 1001. Thus, the laser beam is scattered when transmitted through light-scattering material 1004, and subsequently transmitted through filter 1007 after coherence is sufficiently reduced. Therefore, 100% of the laser beams can be prevented from leaking outside.

### CITATION LIST

### Patent Literature

PTL 1: Japanese Unexamined Patent Application Publication No. 2012-64597

### SUMMARY OF THE INVENTION

### Technical Problems

However, since the emission directions of the laser beam and the illuminating light (white fluorescent light) are the same in the configuration of the conventional illuminating apparatus 1001 illustrated in FIG. 12, there is a problem that when a vehicle equipped with illuminating apparatus 1001 is subjected to a strong impact caused by a traffic accident, etc., fluorescent member 1003, light-scattering material 1004, or filter 1007 is detached at the same time when reflecting mirror 1005 is damaged, and the laser beam directly leaks into the irradiating region of the illuminating light.

Furthermore, there is the problem that when only fluorescent member 1003 is detached, even when the laser beam is scattered by light-scattering material 1004, a part of absorption-type filter 1007 melts, or at least tens of mW of the laser beam leaks into the irradiation region of the illuminating light, even when 99% of the laser beams are cut by filter 1007 because there is a region whose excitation light density is extremely high.

The present disclosure is conceived to solve the above-described problems, and has as an object to provide a light emitting device and an illuminating apparatus that can prevent laser beams from leaking into the irradiating region of fluorescence.

### Solution to Problems

In order to achieve the above object, a light emitting device according to an aspect of the present disclosure includes: a laser light source which emits a laser beam; a fluorescent member which emits fluorescence when irradiated with the laser beam emitted from the laser light source as excitation light; and a light separation element which includes an incidence surface on which the laser beam and the fluorescence are incident, and separates the laser beam and the fluorescence. The light separation element transmits one of the laser beam and the fluorescence which are incident on the light separation element, and reflects an other of the laser beam and the fluorescence. The incidence surface of the light separation element is oblique at least to an incidence direction of the laser beam.

Having the configuration, the laser beam and the fluorescence can be separated and made to travel in different directions. This can prevent the laser beam from leaking into the irradiation region of the fluorescence, even when part of the components of the light emitting device is damaged.

Furthermore, for example, in the light emitting device according to an aspect of the present disclosure, the laser beam emitted from the laser light source has a peak wavelength of less than or equal to 425 nm.

In this case, the laser beam having a short wavelength of less than or equal to 425 nm can be transmitted through or reflected by the light separation element. Thus, fluorescence in the visible light range including blue light can be utilized as white light. Furthermore, it is possible to prevent the laser beam having a short wavelength of less than or equal to 425 nm which is harmful to humans from leaking into the irradiation region of the fluorescence, and thus a safe light emitting device can be realized.

Furthermore, for example, in the light emitting device according to an aspect of the present disclosure, the light separation element transmits the laser beam and reflects the fluorescence, the laser beam and the fluorescence being incident on the light separation element.

Thus, a safer light emitting device can be realized, compared with the case of using a light separation element that reflects a laser beam and transmits fluorescence.

Furthermore, for example, in the light emitting device according to an aspect of the present disclosure, when an angle formed by the incidence surface of the light separation element and an incidence direction of the fluorescence on the incidence surface is α, the fluorescence is reflected by the light separation element in a direction which forms an angle of α with the incidence surface.

Thus, the light separation element can, while separating the laser beam, reflect the fluorescence in a predetermined direction different from the direction in which the fluorescence is incident on the incidence surface (emission direction of the fluorescence from the fluorescent member).

In this case, for example, the light separation element has a function of adjusting an incidence angle, and the fluorescence travels in a direction according to a predetermined angle adjusted within a range of 0°<α<90°.

Because of this, the fluorescence can be adjusted by the light separation element to travel in a desired direction.

Furthermore, for example, in the light emitting device according to an aspect of the present disclosure, the light separation element includes a dielectric multilayer film.

Since the dielectric multilayer film is highly resistant to damage even when a laser beam having high light density is incident on the dielectric multilayer film, a reliable light emitting device can be realized. Furthermore, using the dielectric multilayer film can satisfy both of a high transmittance of the laser beam and a high reflectance of the fluorescence.

Furthermore, the light emitting device according to an aspect of the present disclosure may further include a reflecting mirror which is disposed separate from the light separation element, and reflects the laser beam and the fluorescence toward the light separation element.

Because of this, the fluorescence generated by the fluorescent member can be converged toward the light separation element efficiently. In addition, since the reflecting mirror is disposed separate from the light separation element, the light separation element can be disposed without interference with the reflecting mirror, even when the angle formed by the incidence surface of the light separation element and the incidence direction of the laser beam is sharp.

Furthermore, for example, in the light emitting device according to an aspect of the present disclosure, the reflecting mirror is a parabolic mirror, and the fluorescent member is disposed near a focal point of the parabolic mirror.

Because of this, the fluorescence generated by the fluorescent member can be condensed efficiently and emitted toward the light separation element as collimated light.

Furthermore, for example, in the light emitting device according to an aspect of the present disclosure, the reflecting mirror is an ellipsoidal mirror, the fluorescent member is disposed near a first focal point of the ellipsoidal mirror, and the light separation element is disposed near a second focal point of the ellipsoidal mirror.

Because of this, the laser beam and the fluorescence can be condensed on the second focal point of the ellipsoidal mirror efficiently, and thus the laser beam and the fluorescence which are incident on the light separation element can be separated easily even by the light separation element whose incidence surface area is small.

Furthermore, for example, in the light emitting device according to an aspect of the present disclosure, an aperture is provided in at least a part of the reflecting mirror, the laser light source is disposed on a convex surface side of the reflecting mirror, and the laser beam passes through the aperture and irradiates the fluorescent member.

Because of this, the laser light source is disposed on the side of the reflecting mirror which is opposite to the emission direction of the fluorescence, and thus it is possible to avoid having a shadow of the laser light source cast onto the image of the fluorescence.

Furthermore, for example, the light emitting device according to an aspect of the present disclosure further includes a sensor which detects the laser beam, and the light separation element is disposed between the reflecting mirror and the sensor.

Because of this, since the sensor is disposed on the side of the light separation element which is opposite to the surface of the light separation element which faces the reflecting mirror, trouble such as detachment of the fluorescent member can be detected by monitoring the power (output) of the laser beam using the sensor. Thus, a safer light emitting device can be realized.

Furthermore, for example, the light emitting device according to an aspect of the present disclosure further includes a fluorescent member which is disposed on an optical path of the laser beam transmitted through the light separation element, has a predetermined pattern, and emits fluorescence when irradiated with the laser beam.

Because of this, the light emitting intensity of the fluorescent member which has a predetermined pattern and emits fluorescence can be visually checked, and thus the operation status of the light emitting device can be constantly identified from the simple configuration.

Furthermore, an illuminating apparatus according to an aspect of the present disclosure includes any one of the light emitting devices described above.

By having the configuration, an illuminating apparatus that can prevent laser beams from leaking into the irradiation region of fluorescence can be realized.

### Advantageous Effect of Invention

According to the present disclosure, a light emitting device and an illuminating apparatus that can prevent laser beams from leaking into the irradiation region of fluorescence can be realized.

### BRIEF DESCRIPTION OF DRAWINGS

FIG. 1 is a cross-sectional view of an overall configuration of a light emitting device according to Embodiment 1.

FIG. 2A is a graph illustrating a luminosity function of humans with respect to a wavelength of light.

FIG. 2B is a graph illustrating a transmittance property of a light separation element used in the light emitting device according to Embodiment 1.

FIG. 3 is a diagram illustrating paths of a laser beam and fluorescence emitted from the light emitting device according to Embodiment 1.

FIG. 4 is a cross-sectional view of an overall configuration of a light emitting device according to Embodiment 2.

FIG. 5 is a diagram illustrating paths of a laser beam and fluorescence emitted from the light emitting device according to Embodiment 2.

FIG. 6 is a cross-sectional view of an overall configuration of a light emitting device according to Embodiment 3.

FIG. 7 is a diagram illustrating paths of a laser beam and fluorescence emitted from the light emitting device according to Embodiment 3.

FIG. 8 is a cross-sectional view of an overall configuration of a light emitting device according to a variation of Embodiment 3.

FIG. 9 is a cross-sectional view of an overall configuration of a light emitting device according to Embodiment 4.

FIG. 10 is a diagram illustrating paths of a laser beam and fluorescence emitted from the light emitting device according to Embodiment 4.

FIG. 11 is a schematic diagram illustrating an overall configuration of a light emitting device according to Embodiment 5.

FIG. 12 is a cross-sectional view of an overall configuration of a conventional light emitting device.

### DESCRIPTION OF EXEMPLARY EMBODIMENTS

Embodiments of the present disclosure will be described below with reference to the drawings. The embodiments described below each illustrate a particular example of the present disclosure. Thus, the numerical values, shapes, materials, elements, the arrangement and connection of the elements, etc., indicated in the following embodiments are mere examples, and are not intended to limit the present disclosure. Therefore, among the elements in the following embodiments, elements not recited in any of the independent claims defining the most generic concept of the present disclosure are described as optional elements.

Furthermore, the drawings are schematic and do not necessarily provide precise depictions. Therefore, the scale, etc., is not always the same among the respective drawings. Throughout the drawings, like elements share like reference signs and redundant description is omitted or simplified.

### Embodiment 1

[Configuration of Light Emitting Device]

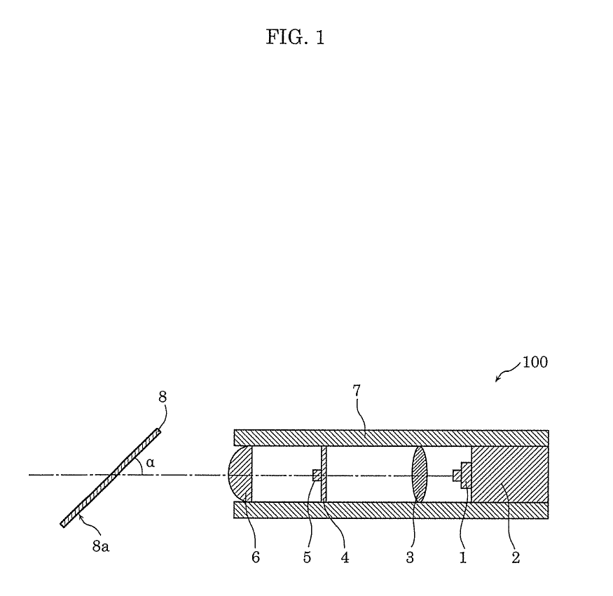

Light emitting device 100 according to Embodiment 1 will be described with reference to FIG. 1. FIG. 1 is a cross-sectional view of an overall configuration of light emitting device 100 according to Embodiment 1.

As illustrated in FIG. 1, light emitting device 100 according to this embodiment includes semiconductor laser element 1, heat sink 2, condenser lens 3, transparent substrate 4, fluorescent member 5, projection lens 6, housing 7, and light separation element 8.

Semiconductor laser element 1 is an example of a laser light source that emits a laser beam, and is a nitride semiconductor light emitting device including a nitride semiconductor light emitting layer, for example. In this embodiment, the peak wavelength of the laser beam emitted from semiconductor laser element 1 is less than or equal to 425 nm. Specifically, semiconductor laser element 1 is an InGaN-based laser diode element which emits a bluish purple laser beam having a peak wavelength of 405 nm.

Heat sink 2 is a metal member including aluminum or copper, for example. Semiconductor laser element 1 is fixed to one end of heat sink 2. The laser beam emitted from semiconductor laser element 1 travels in the opposite direction to heat sink 2.

Condenser lens 3 includes a light-transmitting member such as silica, for example, and is disposed on the laser beam emission side of semiconductor laser element 1. The laser beam emitted from semiconductor laser element 1 is condensed by condenser lens 3. Condenser lens 3 may include an optical system including an optical component group of one or more micro lenses, etc., which does not only condense the incident laser beam but also has a beam shaping function (for shaping into a top-hat emission distribution, for example).

Transparent substrate 4 is a fluorescent member supporting member which supports fluorescent member 5. Transparent substrate 4 is a highly thermal conductive substrate such as a GaN substrate, an SiC substrate, an AlN substrate, or a diamond substrate, for example. For example, a film (dichroic filter film, for example) that transmits the laser beam emitted from semiconductor laser element 1 and reflects the fluorescence generated from fluorescent member 5 is formed on the surface of transparent substrate 4.

Fluorescent member 5 is a phosphor optical element which produces fluorescence, with the incident light as excitation light. In this embodiment, fluorescent member 5 produces fluorescence when irradiated with the laser beam emitted from semiconductor laser element 1 as the excitation light. The phosphor material included in fluorescent member 5 is, for example, a mixture of an SMS fluorescent material (Sr₃MgSi₂O₈: Eu²⁺) for blue light emitting and a BSSON fluorescent material ((Ba, Sr) Si₂O₂N₂: Eu²⁺) for yellow light emitting. SMS for blue light emitting emits blue light when excited by the laser beam emitted from semiconductor laser element 1. BSSON for yellow light emitting emits yellow light when excited by the laser beam emitted from semiconductor laser element 1. The combined light of blue light and yellow light appears white to humans. Thus, white light is emitted from fluorescent member 5 as the combined light of blue light and yellow light, when fluorescent member 5 is irradiated with the laser beam emitted from semiconductor laser element 1. In other words, white fluorescence is obtained from fluorescent member 5.

Projection lens 6 includes a light-transmitting member such as glass or silica, for example, and condenses and projects, onto a desired region, the fluorescence (white light) emitted from fluorescent member 5. In this embodiment, projection lens 6 collimates the fluorescence (white light) emitted from fluorescent member 5, and projects parallel beams onto incidence surface 8a of light separation element 8.

Housing 7 is a hollow cylindrical body, and is a lens barrel formed from a metal material such as aluminum, for example. Semiconductor laser element 1, heat sink 2, condenser lens 3, transparent substrate 4, fluorescent member 5, and projection lens 6 are housed in housing 7. Specifically, heat sink 2 on which semiconductor laser element 1 is disposed is fixed to one end portion in the barrel axis direction of housing 7. In addition, condenser lens 3, transparent substrate 4, fluorescent member 5, and projection lens 6 are disposed in this order along the emission direction of the laser beam from semiconductor laser element 1. Condenser lens 3, transparent substrate 4, and projection lens 6 are fixed to housing 7.

Light separation element 8 separates the laser beam emitted from semiconductor laser element 1 and the fluorescence (white light) emitted from fluorescent member 5. Specifically, light separation element 8 includes incidence surface 8a at which the laser beam and the fluorescence are separated.

The laser beam emitted from semiconductor laser element 1 and the fluorescence emitted from fluorescent member 5 are incident on incidence surface 8a. In this embodiment, the laser beam and the fluorescence emitted from fluorescent member 5 are incident on incidence surface 8a. In other words, the laser beams transmitted without being absorbed by fluorescent member 5 among the laser beams that are emitted from semiconductor laser element 1 and then enter fluorescent member 5, and the fluorescence generated from fluorescent member 5 from the laser beam emitted from semiconductor laser element 1 are incident on incidence surface 8a.

Furthermore, light separation element 8 has a property of transmitting one of the laser beam and the fluorescence which are incident on light separation element 8, and reflecting the other. In this embodiment, light separation element 8 has a property of transmitting the laser beam and reflecting the fluorescence, out of the laser beam and the fluorescence which are incident on light separation element 8. Light separation element 8 having the property described above is a dichroic filter, for example, which includes a transparent substrate having a transparent property with respect to the laser beam emitted from semiconductor laser element 1 and the fluorescence generated from fluorescent member 5, and a dielectric multilayer film of SiO₂ layers and TiO₂ layers stacked alternately on the transparent substrate described above.

Incidence surface 8a of light separation element 8 is oblique at least to the incidence direction of the laser beam. In other words, incidence surface 8a is oblique at least to the direction in which the laser beam is incident on incidence surface 8a. Specifically, incidence surface 8a is oblique to the incidence direction of the laser beam which is not absorbed by fluorescent member 5, among the laser beams that enter fluorescent member 5.

Furthermore, in this embodiment, since the travel direction (optical axis) of the laser beam that is not absorbed by fluorescent member 5 and the optical axis of the fluorescence emitted from fluorescent member 5 are the same, incidence surface 8a is oblique also to the optical axis of the fluorescence emitted from fluorescent member 5.

More specifically, when the angle formed by incidence surface 8a and the extended line extending from a line that connects the light emitting point of semiconductor laser element 1 and the center of fluorescent member 5 (long dashed short dashed line in FIG. 1) is α, light separation element 8 is disposed to satisfy the relationship 0°<α<90°. In other words, light separation element 8 is disposed to be oblique to the extended line described above by an angle α. The angle α is the incidence angle of the laser beam and the fluorescence with respect to incidence surface 8a of light separation element 8.

It should be noted that light separation element 8 is disposed at a position separate from housing 7, but is not limited to such. For example, light separation element 8 may be fixed to housing 7.

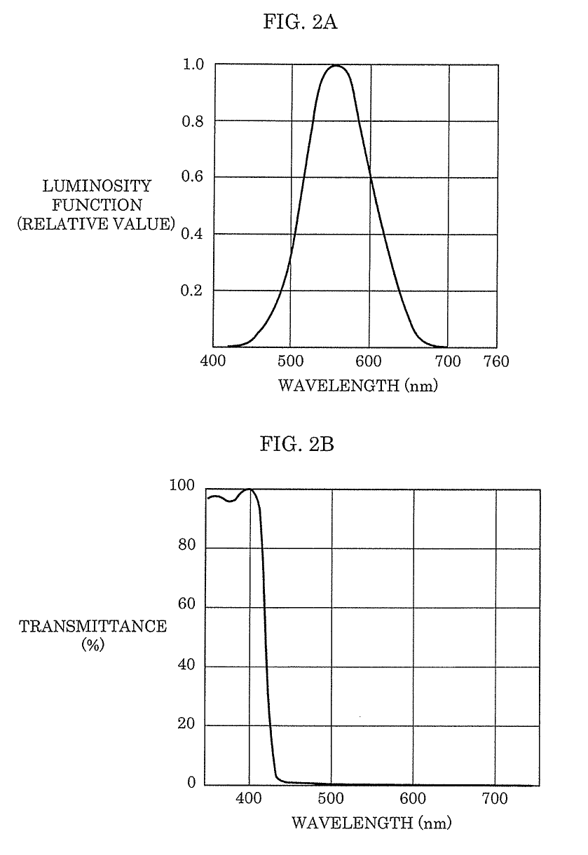

Next, the relationship between the transmittance property of light separation element 8 and the oscillation wavelength of semiconductor laser element 1 will be described with reference to FIG. 2A and FIG. 2B. FIG. 2A is a graph illustrating the luminosity function of humans with respect to the wavelength of light. FIG. 2B is a graph illustrating the transmittance property of light separation element 8 (dichroic filter) used in light emitting device 100 according to Embodiment 1.

As illustrated in FIG. 2A, humans have an extremely low luminosity function with respect to light having a wavelength of less than or equal to 425 nm. Therefore, in this embodiment, the oscillation peak wavelength of semiconductor laser element 1 is set to less than or equal to 425 nm (specifically, nm) and the transmittance property of light separation element 8 is designed such that light having a wavelength of less than 425 nm is transmitted and light having a wavelength of greater than or equal to 425 nm is not transmitted (in other words, is reflected), as illustrated in FIG. 2B. Light separation element 8 having such a design transmits the laser beam from semiconductor laser element 1 and reflects the fluorescence (visible light) emitted from fluorescent member 5 without loss. Therefore, deterioration of light utilization efficiency due to light separation element 8 does not occur.

[Operation of Light Emitting Device]

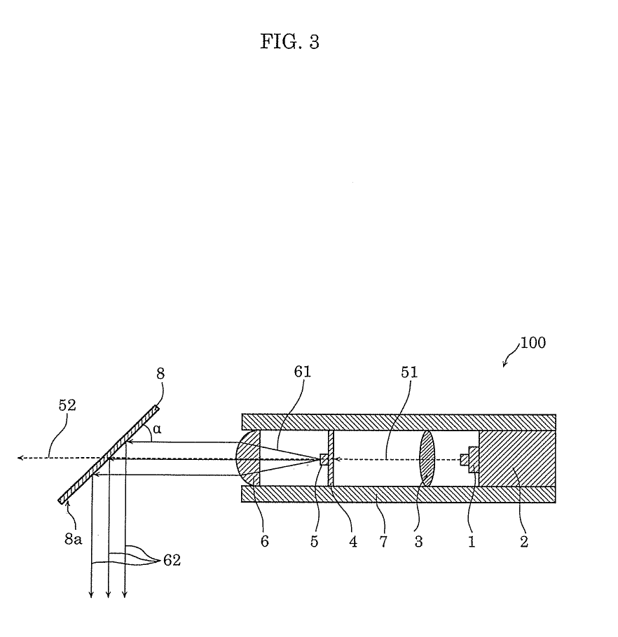

Next, the operation of light emitting device 100 according to Embodiment 1 will be described with reference to FIG. 3. FIG. 3 is a diagram illustrating paths of the laser beam and the fluorescence emitted from light emitting device 100 according to Embodiment 1.

As illustrated in FIG. 3, the bluish purple laser beam 51 emitted from semiconductor laser element 1 is transmitted through transparent substrate 4 and irradiates fluorescent member 5, after being shaped from diverging light to converging light by condenser lens 3. At this time, heat generated by reactive power (input power—optical output) of semiconductor laser element 1 is dissipated from heat sink 2. It should be noted that, although not illustrated, providing a heat dissipation mechanism realized by a cooling fin or a Peltier element in heat sink 2 can further improve the heat dissipation performance of heat sink 2.

A part of laser beam 51 that irradiates fluorescent member 5 is absorbed by fluorescent member 5 and converted into blue light and yellow light. The blue light and the yellow light mix to produce white fluorescence which is the combined light thereof. The white fluorescence 61 generated from fluorescent member 5 is condensed by projection lens 6, emitted out of housing 7, and is incident on light separation element 8. In this embodiment, since light separation element 8 has the property of reflecting the fluorescence emitted from fluorescent member 5, fluorescence 61 which is incident on light separation element 8 is reflected by light separation element 8.

Here, the angle (α) formed by incidence surface 8a and the extended line extending from a line that connects the light emitting point of semiconductor laser element 1 and the center of fluorescent member 5 is the same as the angle formed by incidence surface 8a of light separation element 8 and the incidence direction of fluorescence 61 which is incident on incidence surface 8a (fluorescence emission direction from the fluorescent member). Because of this, the white fluorescence 61 which is incident on light separation element 8 is reflected by light separation element 8 in a direction which forms an angle of α with incidence surface 8a. Specifically, the white fluorescence 61 reflected by light separation element 8 is reflected in the direction which forms an angle of α with incidence surface 8a, and irradiates a predetermined irradiation surface as white illuminating light 62.

On the other hand, the other part of laser beam 51 that irradiates fluorescent member 5 is transmitted through fluorescent member 5 without being absorbed by fluorescent member 5. Laser beam 52 which is not absorbed by fluorescent member 5 is emitted out of housing 7 via projection lens 6 and is incident on light separation element 8. In this embodiment, since light separation element 8 has the property of transmitting the laser beam from semiconductor laser element 1, laser beam 52 which is incident on light separation element 8 is transmitted through light separation element 8 without being reflected by light separation element 8. In other words, laser beam 52 which is incident on light separation element 8 is transmitted through light separation element 8 and travels in a different direction from the white illuminating light 62.

### SUMMARY

As described above, light emitting device 100 according to this embodiment includes: semiconductor laser element 1 which emits laser beam 51; fluorescent member 5 which emits fluorescence 61 when irradiated with laser beam 51 emitted from semiconductor laser element 1 as excitation light; and light separation element 8 which includes incidence surface 8a on which laser beam 52 and fluorescence 61 are incident, and separates laser beam 52 and fluorescence 61. Light separation element 8 transmits one of laser beam and fluorescence 61 which are incident on light separation element 8, and reflects the other of laser beam 52 and fluorescence 61. Incidence surface 8a of light separation element 8 is oblique at least to the incidence direction of laser beam 52.

By using light separation element 8 of which incidence surface 8a is disposed to be oblique to the incidence direction of laser beam 52 as described above, laser beam 52 and fluorescence 61 can be separated and made to travel in different directions. Specifically, laser beam 52 and fluorescence 61 which are incident on light separation element 8 can be separated by light separation element 8 into illuminating light 62 and laser beam 52 to travel in different directions. This can prevent laser beam 52 from leaking into the irradiation region of the fluorescence (illuminating light 62), even when part of the components of light emitting device 100 such as fluorescent member 5 or light separation element 8 is damaged.

Furthermore, in this embodiment, light separation element 8 transmits laser beam 52 and reflects fluorescence 61, laser beam 52 and fluorescence 61 being incident on light separation element 8.

Thus, a safer light emitting device can be realized, compared with the case of using a light separation element that reflects laser beam 52 and transmits fluorescence 61.

Furthermore, in this embodiment, laser beam 51 emitted from semiconductor laser element 1 has a peak wavelength of less than or equal to nm.

In this case, laser beam 51 having a short wavelength of less than or equal to 425 nm can be transmitted through or reflected by light separation element 8. Thus, fluorescence in the visible light range including blue light can be generated by exciting fluorescent member 5 with laser beam 51 having a short wavelength of less than or equal to 425 nm, and the fluorescence can be utilized as white light. Furthermore, laser beam 51 having a short wavelength of less than or equal to 425 nm is harmful to humans, but since laser beam 52 transmitted through fluorescent member 5, out of laser beam 51 which enters fluorescent member 5, is separated from fluorescence 61 (illuminating light 62) by light separation element 8, leaking of laser beam 52 into the irradiation region of illuminating light 62 (fluorescence) can be prevented. Thus, a safe light emitting device can be realized.

Furthermore, in this embodiment, when the incidence angle of fluorescence 61 with respect to incidence surface 8a of light separation element 8 is α, fluorescence 61 is reflected by light separation element 8 in a direction which forms an angle of α with incidence surface 8a.

Thus, light separation element 8 can, while separating laser beam 51, reflect fluorescence 61 in a predetermined direction different from the direction in which fluorescence 61 is incident on incidence surface 8a (emission direction of fluorescence 61 from phosphor 5).

Furthermore, in this embodiment, light separation element 8 includes a dielectric multilayer film.

Since the dielectric multilayer film is highly resistant to damage even when a laser beam having high light density is incident on the dielectric multilayer film, a reliable light emitting device can be realized. Furthermore, by designing the wavelength of light that is transmitted through the dielectric multilayer film and the wavelength of light that is reflected by the dielectric multilayer film according to the optical length of the dielectric multilayer film (film thickness of each layer multiplied by refraction index of each layer), a high laser light transmittance of over 95% and a high fluorescence reflectance of 95% or higher over the entire wavelength range of visible light can be achieved.

### Embodiment 2

[Configuration of Light Emitting Device]

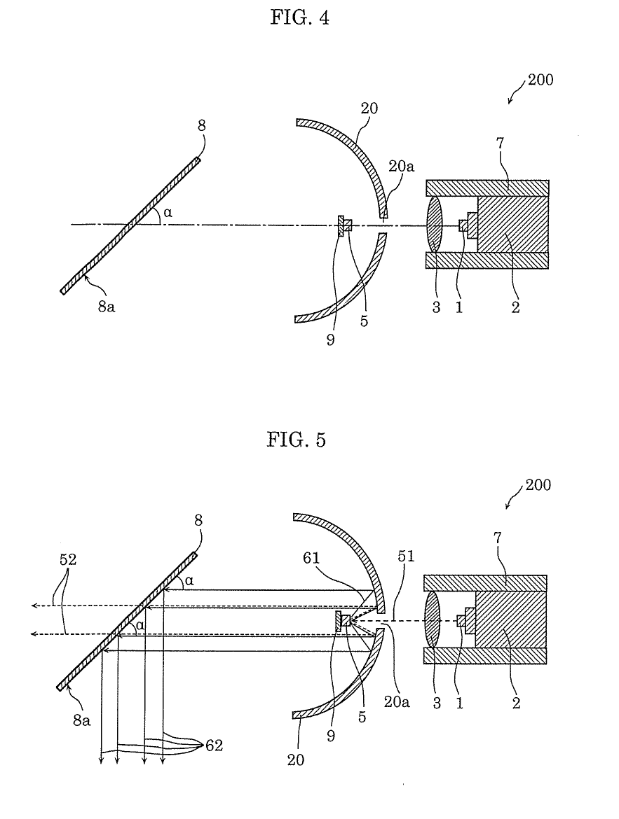

Next, light emitting device 200 according to Embodiment 2 will be described with reference to FIG. 4. FIG. 4 is a cross-sectional view of an overall configuration of light emitting device 200 according to Embodiment 2.

As in Embodiment 1, light emitting device 200 according to Embodiment 2 includes semiconductor laser element 1, heat sink 2, condenser lens 3, fluorescent member 5, housing 7, and light separation element 8. Light emitting device 200 further includes reflective substrate 9 and reflecting mirror 20.

Reflective substrate 9 supports fluorescent member 5 and also reflects the fluorescence and the laser beam emitted from fluorescent member 5.

Reflecting mirror 20 is a reflector having a reflective face on the surface. Reflecting mirror 20 may be a structure in a predetermined shape on which a metal thin film serving as a reflective face is formed, or the entire reflecting mirror 20 may be formed from metal.

In this embodiment, reflecting mirror 20 is a parabolic mirror. In other words, the reflective face of reflecting mirror 20 is a concave surface of a paraboloid of revolution. Furthermore, aperture 20a is provided in at least a part of reflecting mirror 20. Specifically, aperture 20a is a through hole provided at the apex portion of reflecting mirror 20.

Housing 7 is disposed on the convex surface side of reflecting mirror 20. As in Embodiment 1, semiconductor laser element 1, heat sink 2, and condenser lens 3 are disposed inside of housing 7. Accordingly, semiconductor laser element 1, heat sink 2, and condenser lens 3 are disposed on the convex surface side of reflecting mirror 20. Specifically, reflecting mirror 20 is disposed such that aperture 20a is opposite condenser lens 3.

Fluorescent member 5 supported by reflective substrate 9 is disposed on the concave surface side of reflecting mirror 20. Fluorescent member 5 is disposed near the focal point of reflecting mirror 20 which is a parabolic mirror.

The laser beam emitted from semiconductor laser element 1 passes through aperture 20a and irradiates fluorescent member 5. Specifically, the laser beam condensed by condenser lens 3 passes through aperture 20a and guided to the concave surface side so as to pass through the focal point of reflecting mirror 20. Accordingly, fluorescent member 5 is excited and emits fluorescence. Reflecting mirror 20 reflects the fluorescence from fluorescent member 5 and the laser beam that is not absorbed by fluorescent member 5 toward light separation element 8.

Reflecting mirror 20 and light separation element 8 are disposed spaced apart. Specifically, when the angle formed by incidence surface 8a and the extended line extending from a line that connects the light emitting point of semiconductor laser element 1 and the center of fluorescent member 5 (long dashed and short dashed line in FIG. 4) is α, light separation element 8 is disposed at a position separate from and on the light emitting surface side of reflecting mirror 20 to satisfy the relationship 0°<α<90°. In other words, light separation element 8 is disposed to be oblique to the extended line described above by an angle α.

[Operation of Light Emitting Device]

Next, the operation of light emitting device 200 according to Embodiment 2 will be described with reference to FIG. 5. FIG. 5 is a diagram illustrating paths of a laser beam and fluorescence emitted from light emitting device 200 according to Embodiment 2.

As illustrated in FIG. 5, the bluish purple laser beam 51 emitted from semiconductor laser element 1 passes through aperture 20a of reflecting mirror 20 and irradiates fluorescent member 5, after being shaped from diverging light to converging light by condenser lens 3.

A part of laser beam 51 that irradiates fluorescent member 5 is absorbed by fluorescent member 5 and converted into blue light and yellow light. The blue light and the yellow light mix to produce white fluorescence which is the combined light thereof. The white fluorescence 61 generated from fluorescent member 5 is reflected by the concave surface (reflective face) of reflecting mirror 20 and collimated, and then emitted out of reflecting mirror 20 to be incident on light separation element 8. At this time, since reflective substrate 9 is disposed, all of fluorescence 61 emitted from fluorescent member 5 in all directions can be reflected by reflective substrate 9 toward the inner surface of reflecting mirror 20 so as to be made incident on light separation element 8.

In this embodiment too, light separation element 8 has the property of reflecting the fluorescence emitted from fluorescent member 5, and thus fluorescence 61 which is incident on light separation element 8 is reflected by light separation element 8. Specifically, as in Embodiment 1, the white fluorescence 61 reflected by light separation element 8 is reflected in a direction which forms an angle of α with incidence surface 8a and is emitted on a predetermined irradiation surface as white illuminating light 62.

On the other hand, the other part of laser beam 51 that irradiates fluorescent member 5 is not absorbed by fluorescent member 5. Laser beam 52 that is not absorbed by fluorescent member 5 is reflected by the concave surface of reflecting mirror 20 after being reflected by fluorescent member 5 or reflective substrate 9, and then emitted out of reflecting mirror 20 so as to be incident on light separation element 8.

In this embodiment too, since light separation element 8 has the property of transmitting the laser beam from semiconductor laser element 1, laser beam 52 that is incident on light separation element 8 is transmitted through light separation element 8 without being reflected by light separation element 8. In other words, laser beam 52 that is incident on light separation element 8 is transmitted through light separation element 8 and travels in a different direction from the white illuminating light 62.

[Summary]

As described above, light emitting device 200 according to this embodiment has a similar configuration to the configuration in Embodiment 1. Accordingly, similar effects as in Embodiment 1 can be produced. In other words, leaking of laser beam 52 into the irradiation region of the fluorescence (illuminating light 62) can be prevented.

Furthermore, light emitting device 200 according to this embodiment includes reflecting mirror 20 which is disposed separate from light separation element 8, and reflects laser beam 51 and fluorescence 61 toward light separation element 8.

Because of this, fluorescence 61 emitted from fluorescent member 5 in all directions can be converged toward light separation element 8 efficiently. Particularly, in this embodiment, since reflective substrate 9 is disposed, fluorescence 61 emitted from fluorescent member 5 in all directions can be converged toward light separation element 8 in an extremely efficient manner. In addition, since reflecting mirror 20 is disposed separate from light separation element 8, light separation element 8 can be disposed without interference with reflecting mirror 20, even when the angle formed by incidence surface 8a of light separation element 8 and the incidence direction of laser beam 52 is sharp.

Furthermore, in this embodiment, reflecting mirror 20 is a parabolic mirror, and fluorescent member 5 is disposed near the focal point of the parabolic mirror.

Because of this, fluorescence 61 emitted from fluorescent member 5 can be condensed efficiently and emitted toward light separation element 8 as collimated light.

Furthermore, in this embodiment, aperture 20a is provided in at least a part of reflecting mirror 20, semiconductor laser element 1 is disposed on the convex surface side of reflecting mirror 20, and laser beam 51 passes through aperture 20a and irradiates fluorescent member 5.

Because of this, semiconductor laser element 1 is disposed on the side of reflecting mirror 20 which is opposite to the emission direction of fluorescence 61. Thus, it is possible to avoid having a shadow of semiconductor laser element 1 cast onto the image of fluorescence 61.

It should be noted that, although an example in which the white fluorescence 61 generated from fluorescent member 5 is collimated by reflecting mirror 20 is presented in this embodiment, the adjustment for converging or dispersing the white fluorescence 61 may be performed by moving fluorescent member 5 along the optical axis of laser beam 51 near the focal point of reflecting mirror 20. Accordingly, white illuminating light 62 in a desired size can be obtained.

### Embodiment 3

[Configuration of Light Emitting Device]

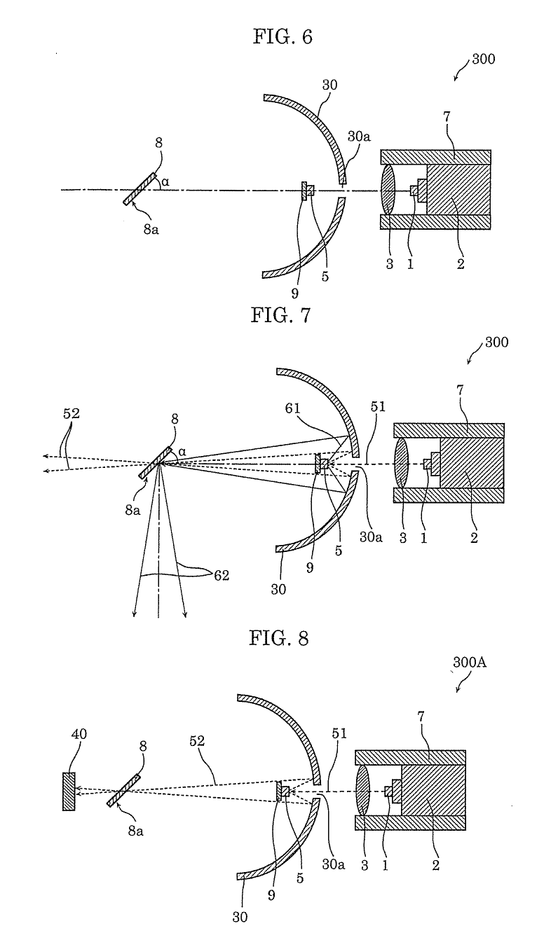

Next, light emitting device 300 according to Embodiment 3 will be described with reference to FIG. 6. FIG. 6 is a cross-sectional view of an overall configuration of light emitting device 300 according to Embodiment 3.

The shape of the reflecting mirror is different between light emitting device 300 according to this embodiment illustrated in FIG. 6 and light emitting device 200 according to Embodiment 2 illustrated in FIG. 4. Specifically, a parabolic mirror is used as reflecting mirror 20 in Embodiment 2 described above, whereas an ellipsoidal mirror is used as reflecting mirror 30 in this embodiment. In other words, light emitting device 300 according to this embodiment has the configuration of light emitting device 200 according to Embodiment 2 described above, with reflecting mirror 20 replaced with reflecting mirror 30.

Reflecting mirror 30 is a reflector having a reflective face on the surface. The reflective face of reflecting mirror 30 which is an ellipsoidal mirror is a concave surface of an ellipsoid of revolution. Furthermore, aperture 30a is provided in at least a part of reflecting mirror 30. Specifically, aperture 30a is a through hole provided at the apex portion of the long axis of reflecting mirror 30.

It should be noted that reflecting mirror 30 may be a structure in a predetermined shape on which a metal thin film serving as a reflective face is formed, or the entire reflecting mirror 30 may be formed from metal.

Fluorescent member 5 supported by reflective substrate 9 is disposed near the first focal point (primary focal point) of reflecting mirror 30 (ellipsoidal mirror). Furthermore, light separation element 8 is disposed near the second focal point (secondary focal point) of reflecting mirror 30 (ellipsoidal mirror). The first focal point and the second focal point are the focal points of the ellipsoid of revolution included in reflecting mirror 30.

[Operation of Light Emitting Device]

Next, the operation of light emitting device 300 according to Embodiment 3 will be described with reference to FIG. 7. FIG. 7 is a diagram illustrating paths of a laser beam and fluorescence emitted from light emitting device 300 according to Embodiment 3.

As illustrated in FIG. 7, the bluish purple laser beam 51 emitted from semiconductor laser element 1 passes through aperture 30a of reflecting mirror 30 and irradiates fluorescent member 5 disposed near the first focal point of reflecting mirror 30, after being shaped from diverging light to converging light by condenser lens 3.

A part of laser beam 51 that irradiates fluorescent member 5 is absorbed by fluorescent member 5 and converted into blue light and yellow light. The blue light and the yellow light mix to produce white fluorescence which is the combined light thereof. The white fluorescence 61 generated from fluorescent member 5 is emitted out of reflecting mirror 30 as converging light after being reflected by the concave surface (reflective face) of reflecting mirror 30, and then condensed on the second focal point of the ellipsoidal of revolution included in reflecting mirror 30. Since light separation element 8 is disposed near the second focal point, the white fluorescence 61 condensed on the second focal point is incident on light separation element 8. At this time, since reflective substrate 9 is disposed, all of fluorescence 61 emitted from fluorescent member 5 in all directions can be reflected by reflective substrate 9 toward the inner surface of reflecting mirror 30 and made incident on light separation element 8.

In this embodiment too, since light separation element 8 has the property of reflecting the fluorescence emitted from fluorescent member 5, fluorescence 61 which is incident on light separation element 8 is reflected by light separation element 8. Specifically, as in Embodiment 1, the white fluorescence 61 reflected by light separation element 8 is reflected in a direction which forms an angle of α with incidence surface 8a and is emitted on a predetermined irradiation surface as white illuminating light 62.

On the other hand, the other part of laser beam 51 that irradiates fluorescent member 5 is not absorbed by fluorescent member 5. Laser beam 52 that is not absorbed by fluorescent member 5 is reflected by the concave surface of reflecting mirror 30 after being reflected by fluorescent member 5 or reflective substrate 9, and then emitted out of reflecting mirror 30 to be incident on light separation element 8.

In this embodiment too, since light separation element 8 has the property of transmitting the laser beam from semiconductor laser element 1, laser beam 52 that is incident on light separation element 8 is transmitted through light separation element 8 without being reflected by light separation element 8. In other words, laser beam 52 that is incident on light separation element 8 is transmitted through light separation element 8 and travels in a different direction from the white illuminating light 62.

[Summary]

As described above, light emitting device 300 according to this embodiment has a similar configuration to the configurations in Embodiments 1 and 2. Accordingly, similar effects as in Embodiments 1 and 2 can be produced. Specifically, effects such as being able to prevent leaking of laser beam 52 into the irradiation region of the fluorescence (illuminating light 62) can be obtained.

Furthermore, in this embodiment, reflecting mirror 30 is an ellipsoidal mirror, fluorescent member 5 is disposed near the first focal point of the ellipsoidal mirror, and light separation element 8 is disposed near the second focal point of the ellipsoidal mirror.

Because of this, the laser beam and the fluorescence emitted from the first focal point of the ellipsoidal mirror can be condensed on the second focal point of the ellipsoidal mirror efficiently. Thus, laser beam 52 and fluorescence 61 which are incident on light separation element 8 can be separated easily even by light separation element 8 whose incidence surface area is small.

### Variation of Embodiment 3

FIG. 8 is a cross-sectional view of an overall configuration of light emitting device 300A according to a variation of Embodiment 3.

As illustrated in FIG. 8, light emitting device 300A according to this variation includes sensor 40 which detects a laser beam, added to light emitting device 300 according to the foregoing embodiment.

Sensor 40 is disposed on the side of light separation element 8 which is opposite to the surface of light separation element 8 which faces reflecting mirror 30 (incidence surface 8a). In other words, light separation element 8 is disposed between reflecting mirror 30 and sensor 40. Sensor 40 is positioned on the optical path of laser beam 52 that is transmitted through light separation element 8.

In this variation, trouble such as detachment of fluorescent member 5 can be detected by monitoring the power of the laser beam using sensor 40, and thus a safer light emitting device can be realized.

It should be noted that, although an example in which the power of the laser beam is monitored by sensor 40 is described in this variation, instead of sensor 40, a fluorescent member may be disposed on the optical path of laser beam 52 transmitted through light separation element 8, have a predetermined pattern, and emit fluorescence when irradiated with laser beam 52.

Accordingly, the light emitting intensity of the fluorescent member which has a predetermined pattern and emits fluorescence can be visually checked, and thus the operation status of the light emitting device can be constantly identified from the simple configuration.

It should be noted that this variation can be applied to the other embodiments. In other words, the configuration in which sensor 40 or a fluorescent member which has a predetermined pattern is disposed on the optical path of laser beam 52 transmitted through light separation element 8 may be applied to the light emitting devices according to the other embodiments.

### Embodiment 4

[Configuration of Light Emitting Device]

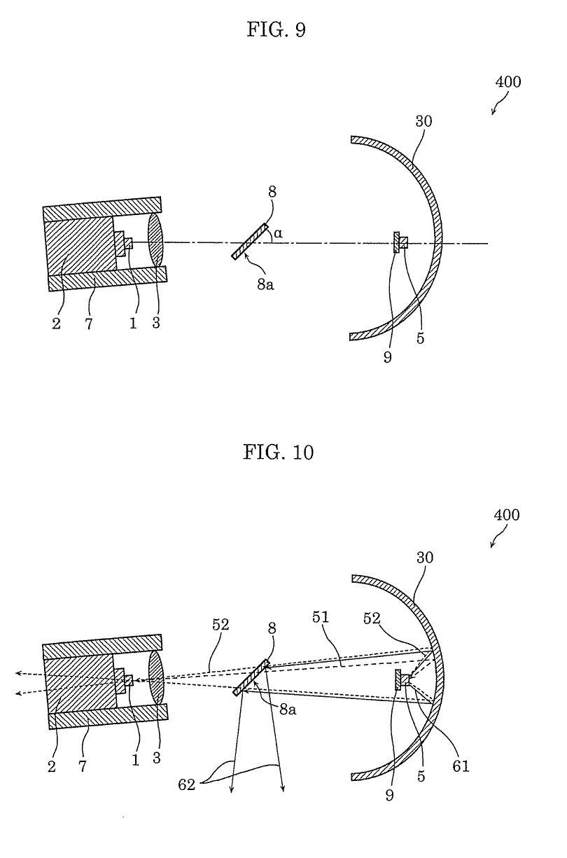

Next, light emitting device 400 according to Embodiment 4 will be described with reference to FIG. 9. FIG. 9 is a cross-sectional view of an overall configuration of light emitting device 400 according to Embodiment 4.

The position of semiconductor laser element 1 is different between light emitting device 400 according to this embodiment illustrated in FIG. 9 and light emitting device 300 according to Embodiment 3 illustrated in FIG. 6.

Specifically, in this embodiment, semiconductor laser element 1 is disposed on the concave surface side of reflecting mirror 30 (ellipsoidal mirror). In other words, semiconductor laser element 1 is disposed such that the emitted laser beam 51 is directly incident on the concave surface (reflective face) of reflecting mirror 30. It should be noted that, since semiconductor laser element 1 is disposed inside of housing 7, housing 7 is also disposed on the concave surface side of reflecting mirror 30.

As in Embodiment 3 described above, fluorescent member 5 supported by reflective substrate 9 is disposed near the first focal point (primary focal point) of reflecting mirror 30. Furthermore, semiconductor laser element 1 is disposed such that the light emitting point of semiconductor laser element 1 is positioned near the second focal point (secondary focal point) of reflecting mirror 30.

In this embodiment, for example, light separation element 8 is disposed between reflecting mirror 30 and semiconductor laser element 1, and near the second focal point of reflecting mirror 30. In other words, for example, light separation element 8 is disposed as close as possible to the second focal point (in other words, semiconductor laser element 1) within a range that interference with housing 7 does not occur.

It should be noted that, unlike Embodiment 3 described above, in this embodiment, aperture 30a is not provided in reflecting mirror 30.

[Operation of Light Emitting Device]

Next, the operation of light emitting device 400 according to Embodiment 4 will be described with reference to FIG. 10. FIG. 10 is a diagram illustrating paths of a laser beam and fluorescence emitted from light emitting device 400 according to Embodiment 4.

As illustrated in FIG. 10, the bluish purple laser beam 51 emitted from semiconductor laser element 1 is emitted toward the reflective face (concave surface) of reflecting mirror 30, after being shaped from diverging light to converging light by condenser lens 3. Laser beam 51 is reflected at one point of the reflective face (concave surface) of reflecting mirror 30 and irradiates fluorescent member 5 disposed near the first focal point of reflecting mirror 30.

A part of laser beam 51 that irradiates fluorescent member 5 is absorbed by fluorescent member 5 and converted into blue light and yellow light. The blue light and the yellow light mix to produce white fluorescence which is the combined light thereof. The white fluorescence 61 generated from fluorescent member 5 travels to be condensed on the second focal point of reflecting mirror 30, after being reflected by the reflective face (concave surface) of reflecting mirror 30. At this time, in this embodiment, since light separation element 8 is disposed in front of the second focal point of reflecting mirror 30, the white fluorescence 61 reflected by reflecting mirror 30 is not condensed on the second focal point and is incident on light separation element 8.

In this embodiment too, since light separation element 8 has the property of reflecting the fluorescence emitted from fluorescent member 5, fluorescence 61 which is incident on light separation element 8 is reflected by light separation element 8. Specifically, as in Embodiment 1, the white fluorescence 61 is reflected by light separation element 8 in a direction which forms an angle of α with incidence surface 8a, and is emitted on a predetermined irradiation surface as white illuminating light 62.

On the other hand, the other part of laser beam 51 that irradiates fluorescent member 5 is not absorbed by fluorescent member 5. Laser beam 52 that is not absorbed by fluorescent member 5 is reflected by the concave surface of reflecting mirror 30 after being reflected by fluorescent member 5 or reflective substrate 9, and then travels to be condensed on the second focal point of the ellipsoidal of revolution included in reflecting mirror 30. At this time, in this embodiment, since light separation element 8 is disposed in front of the second focal point, laser beam 52 reflected by reflecting mirror 30 is incident on light separation element 8.

In this embodiment too, since light separation element 8 has the property of transmitting the laser beam from semiconductor laser element 1, laser beam 52 that is incident on light separation element 8 is transmitted through light separation element 8 without being reflected by light separation element 8. In other words, laser beam 52 that is incident on light separation element 8 is transmitted through light separation element 8 and travels in a different direction from the white illuminating light 62.

[Summary]

As described above, light emitting device 400 according to this embodiment has a similar configuration to the configurations of Embodiments 1 and 2. Accordingly, similar effects as in Embodiments 1 and 2 can be produced. Specifically, effects such as being able to prevent leaking of laser beam 52 into the irradiation region of the fluorescence (illuminating light 62) can be obtained.

Furthermore, in light emitting device 400 according to this embodiment, reflecting mirror 30 does not require an aperture for letting laser beam 51 pass through. Thus, fluorescence 61 emitted in all directions can be condensed more efficiently and separated into the white illuminating light 62 and laser beam 52 by light separation element 8 disposed in front of the second focal point of reflecting mirror 30 so that each of the white illuminating light 62 and laser beam 52 is emitted in a different direction from each other.

### Embodiment 5

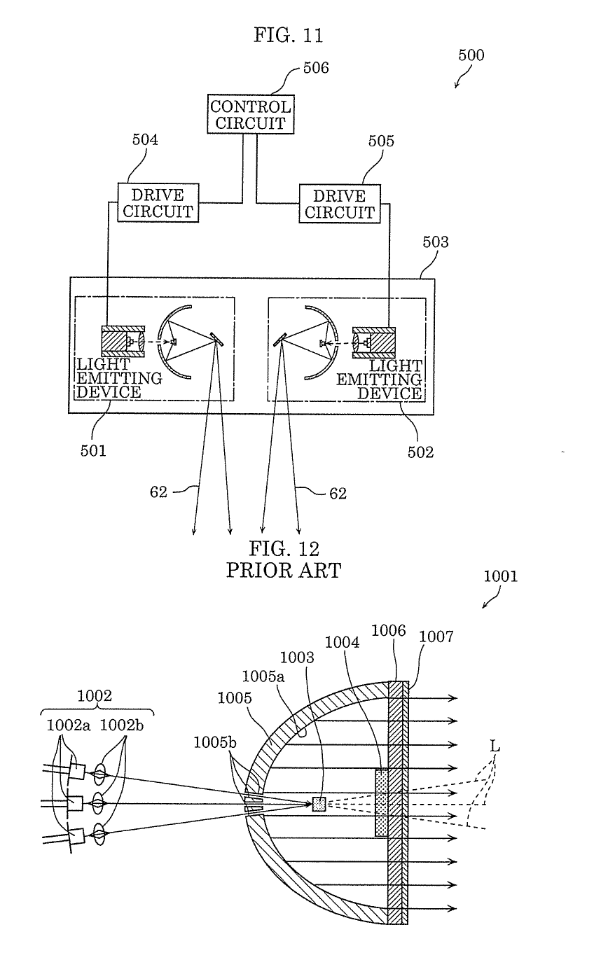

Next, light emitting device 500 according to Embodiment 5 will be described with reference to FIG. 11. FIG. 11 is a schematic diagram illustrating an overall configuration of light emitting device 500 according to Embodiment 5.

Light emitting device 500 according to Embodiment 5 is a headlamp used as vehicular lighting, for example. Generally, a pair of headlamps of symmetrical form are mounted on the right and left of the front of a vehicle.

Illuminating apparatus 500 illustrated in FIG. 11 is a single headlamp, and includes two light emitting devices 501 and 502. Light emitting devices 501 and 502 are disposed in fixture 503. Light emitting devices 501 and 502 both have the configuration of light emitting device 300 according to Embodiment 3 described above.

It should be noted that optimization to adapt light emitting device 501 to distant irradiation and light emitting device 502 to wide-range irradiation may be carried out by adopting mutually different designs for the shape of reflecting mirror 30 (concave shape) or the position of fluorescent member 5.

A desired current or voltage is applied to the semiconductor laser elements of light emitting devices 501 and 502 by drive circuits 504 and 505. Control circuit 506 controls the turning ON and OFF or the drive current amount of drive circuits 504 and 505. Instructions necessary to ensure visibility are given to control circuit 506 from the driver or the automatic driving system.

In this embodiment, since a semiconductor laser element which is a point light source is used, the reflecting mirror can be small, compared with an illuminating apparatus using a halogen lamp or an LED. Accordingly, illuminating apparatus 500 according to this embodiment is suitable for size, thickness, and weight reduction.

In addition, illuminating apparatus 500 according to this embodiment has the configuration of light emitting device 300 according to Embodiment 3 described above, and thus leaking of harmful laser beams onto the irradiated road surface can be prevented even when part of the components such as the fluorescent member or the light separation element is damaged because the emission directions of the laser beam and the fluorescence (illuminating light) are made different from each other by the light separation element. Thus, safe vehicular lighting can be realized.

Furthermore, in this embodiment, the function of adjusting an angle may be added to the light separation elements of light emitting devices 501 and 502. Specifically, the light separation element has the function of adjusting the incidence angle of the laser beam or the fluorescence which is incident on the light separation element, and the fluorescence separated by the light separation element travels in a direction according to a predetermined angle adjusted within the range of 0°<α<90°. Accordingly, the fluorescence can be adjusted by the light separation element to travel in a desired direction.

When the light separation element has the function of adjusting an angle as described above, the beam of illuminating apparatus 500 can be easily scanned left and right relative to the direction of travel of the vehicle. Even when the vehicle goes around a curve, the road surface, etc., in the direction of travel of the vehicle can be irradiated properly, and thus safety can be improved.

It should be noted that, in this embodiment, light emitting device 300 according to Embodiment 3 is used as light emitting devices 501 and 502, but light emitting devices 501 and 502 are not limited to such. For example, the light emitting device according to another embodiment or variation thereof may be used as light emitting devices 501 and 502. Furthermore, although an example of an illuminating apparatus for vehicular lighting is described in this embodiment, this embodiment can also be applied to an illuminating apparatus used as lighting equipment in a building.

### OTHER VARIATIONS, ETC.

Although light emitting devices and illuminating apparatuses according to the present disclosure are described above based on the foregoing embodiments and variation thereof, the present disclosure is not limited to the foregoing embodiments and variation thereof.

For example, in the foregoing embodiments, the configuration of the light emitting device is such that white light produced by a blue phosphor and a yellow phosphor is emitted, but is not limited to such. For example, the light emitting device may be configured to emit white light by using a blue phosphor, a red phosphor, and a green phosphor, or may be configured to emit white light by using another combination.

The present disclosure includes, for example, forms that can be obtained by various modifications to the respective embodiments and variations that may be conceived by those skilled in the art, and forms obtained by arbitrarily combining elements and functions in the respective embodiments without departing from the essence of the present disclosure.

### INDUSTRIAL APPLICABILITY

A light emitting device according to the present disclosure can be applied to a spotlight used in a factory, gym, etc., industrial lighting such as store lighting, vehicular lighting such as headlamps, and others.

### REFERENCE MARKS IN THE DRAWINGS

1 semiconductor laser element (laser light source)
2 heat sink
3 condenser lens
4 transparent substrate
5 fluorescent member
6 projection lens
7 housing
8 light separation element
8a incidence surface
9 reflective substrate
20, 30 reflecting mirror
20a, 30a aperture
40 sensor
51, 52 laser beam
61 fluorescence
62 illuminating light
100, 200, 300, 300A, 400, 501, 502 light emitting device
500 illuminating apparatus
503 fixture
504, 505 drive circuit
506 control circuit

1. A light emitting device, comprising:
a laser light source which emits a laser beam;
a fluorescent member which emits fluorescence when irradiated with the laser beam emitted from the laser light source;
a light separation element on which the laser beam and the fluorescence are incident, and which causes the laser beam and the fluorescence to travel in mutually different directions; and,
a sensor which is disposed at a position on an optical path of the laser beam traveling from the light separation element, and on which the laser beam is incident.

2. The light emitting device according to claim 1, wherein
the laser beam emitted from the laser light source has a peak wavelength of less than or equal to 425 nm.

3. The light emitting device according to claim 1, wherein
the light separation element transmits the laser beam and reflects the fluorescence, the laser beam and the fluorescence being incident on the light separation element.

4. The light emitting device according to claim 3, wherein
when an angle formed by an incidence surface of the light separation element and an incidence direction of the fluorescence on the incidence surface is α, the fluorescence is reflected by the light separation element in a direction which forms an angle of α with the incidence surface.

5. The light emitting device according to claim 4, wherein
the fluorescence travels in a direction according to an angle 0°<α<90°.

6. The light emitting device according to claim 1, wherein
the light separation element includes a dielectric multilayer film.

7. The light emitting device according to claim 1, further comprising:
a reflecting mirror which is disposed separate from the light separation element, and reflects the laser beam and the fluorescence toward the light separation element.

8. The light emitting device according to claim 7, wherein
the reflecting mirror is a parabolic mirror, and the fluorescent member is disposed near a focal point of the parabolic mirror.

9. The light emitting device according to claim 7, wherein
the reflecting mirror is an ellipsoidal mirror, the fluorescent member is disposed near a first focal point of the ellipsoidal mirror, and the light separation element is disposed near a second focal point of the ellipsoidal mirror.

10. The light emitting device according to claim 7, wherein
an aperture is provided in at least a part of the reflecting mirror, the laser light source is disposed on a convex surface side of the reflecting mirror, and the laser beam passes through the aperture and irradiates the fluorescent member.

11. The light emitting device according to claim 7, wherein
the light separation element is disposed between the reflecting mirror and the sensor.

12. (canceled)

13. An illuminating apparatus, comprising:
the light emitting device according to claim 1.

14. The light emitting device according to claim 1, wherein
the light separation element causes the laser beam or the fluorescence which is incident on the light separation element to travel in a direction oblique by an angle α to an optical axis of the laser beam at a time of emission from the laser light source, where a satisfies 0°<α<90°.
